(19) United States
(12) Patent Application Publication
(10) Pub. No.: US 2007/0022572 A1
(43) Pub. Date: Feb. 1, 2007

(54) Tool handle

(76) Inventor: William R. Rogers, Bryan, TX (US)

Correspondence Address: ADLER & ASSOCIATES, 8011 Candle Lane, Houston, TX, 77071, US

(21) Appl. No.: 11/189,590

(22) Filed: Jul. 26, 2005

(51) Int. Cl. E05B 1/00

(52) U.S. Cl. 16/436

(57) ABSTRACT

The present invention provides a tool handle comprising an elongate shaft having a work end and a curved gripping end. The work end is adapted to be secured to a tool head and the curved gripping end is adapted to downwardly curve from a centerline through the elongate shaft to form an obtuse included angle. Also provided are tools comprising the tool handle and a tool head.

### BACKGROUND OF THE INVENTION

1. Field of the Invention

The present invention relates generally to the field of handles for, inter alia, lawn, garden and construction tools. More specifically, the present invention relates to a tool handle having a curved gripping configuration for easier gripping and manipulation.

2. Description of the Related Art

Commonly, tool handles for tool heads, such as for shovels or spades, simply are a single straight shaft with the tool head attached at one end that require an inline grip for use. Tool handles using a D-handle are an improvement over those having an inline grip. However, neither handle is particularly ergonomically beneficial in maintaining a more natural or neutral position during use. To use tools with these tool handles requires significant rotation of at least the wrist, elbow and shoulder and bending at the waist causing undue stress and strain on these joints and the back.

Many tool handles have been modified to incorporate a second or auxiliary handle closer to the handle grip to assist in lifting. By not having to bend so far to grasp the auxiliary handle, a user can lift with his or her legs thereby alleviating back strain during use of the tool.

U.S. Pat. Nos. 5,499,852, 5,921,600 and 6,062,619 and U.S. Publication No. 2003/0116982 all disclose prior art attempts to rectify this problem. For example, U.S. Design Pat. No. 369,083, issued on Apr. 23, 1996 to Ronald Tallman, shows an ornamental design for a cam action handle. The Tallman patent does not suggest an ergonomically designed tool handle according to the claimed invention.

U.S. Patent Application Publication No. 2002/01167791A1, published on Aug. 29, 2002 for Grady et al., describes an illuminated grab handle assembly that includes a generally curved handle, an illumination source positioned remotely from, and for illuminating, the generally curved handle. The Grady et al. application does not suggest an ergonomically designed tool handle according to the claimed invention.

U.S. Pat. No. 845,592, issued on Feb. 26, 1907 to Frank Stewart, describes a shovel handle with a handgrip or handhold at a point intermediate its ends. The Stewart patent does not suggest an ergonomically designed tool handle according to the claimed invention.

U.S. Pat. No. 3,751,094, issued on Aug. 7, 1973 to Gerard M. Bohler, describes an auxiliary handle which is readily securable to a regular handle of an implement. The Bohler patent does not suggest an ergonomically designed tool handle according to the claimed invention.

U.S. Pat. No. 3,888,535, issued on Jun. 10, 1975 to Charles Russo, describes a fireman's pike pole with a head of generally triangular configuration with a longitudinally extending pointed portion and a laterally extending hook. The Russo patent does not suggest an ergonomically designed tool handle according to the claimed invention.

U.S. Pat. No. 3,933,346, issued on Jan. 20, 1976 to Leonard J. Carver, describes a sensor alarm including a sensor for detecting heat, smoke, noxious gases, and the like and an alarm for warning of an alarm condition coupled to the sensor. Black does not suggest an ergonomically designed tool handle according to the claimed invention.

U.S. Pat. No. 4,701,142, issued on Oct. 20, 1987 to William Merritt, describes a handle to the shaft of a paddle that has a grip portion and spaced outwardly extending arms on the grip portion. The Merritt patent does not suggest an ergonomically designed tool handle according to the claimed invention.

U.S. Pat. No. 4,704,758, issued on Nov. 10, 1987 to Charles W. Hoffman, describes adjustable handle constructions for long handled implements. Hoffman does not suggest an ergonomically designed tool handle according to the claimed invention.

U.S. Pat. No. 4,958,407, issued on Sep. 25, 1990 to Samuel V Johnson, describes an auxiliary tool handle for attachment to cylindrical tool handles. The Johnson patent does not suggest an ergonomically designed tool handle according to the claimed invention.

U.S. Pat. No. 5,125,130, issued on Jun. 30, 1992 to Walter F. Stanish, describes an ergonomic handle for tools and sporting equipment. The Stanish patent does not suggest an ergonomically designed tool handle according to the claimed invention.

U.S. Pat. No. 5,159,769, issued on Nov. 3, 1992 to Nicol Odorisio, describes materials handling devices. Odorisio does not suggest an ergonomically designed tool handle according to the claimed invention.

U.S. Pat. No. 5,315,724, issued on May 31, 1994 to Mark Trujillo et al., describes a combination fire axe that includes an elongated handle, a head member disposed at one end of the handle, and a pike member disposed at the opposite end of the handle. The Trujillo et al. does not suggest an ergonomically designed tool handle according to the claimed invention.

U.S. Pat. No. 5,400,471, issued on Mar. 28, 1995 to William H. Lichfield, describes an auxiliary handle for use on a hand held implement. The Lichfield patent does not suggest an ergonomically designed tool handle according to the claimed invention.

U.S. Pat. No. 5,432,978, issued on Jul. 18, 1995 to W. Kenneth Menke et al., describes a fire fighting tool with a handle that is removably and adjustably attached to a pole. The Menke et al. patent does not suggest an ergonomically designed tool handle according to the claimed invention.

U.S. Pat. No. 5,474,350, issued on Dec. 12, 1995 to Serge Gauthier, describes a three-part auxiliary shaft assembly. The Gauthier patent does not suggest an ergonomically designed tool handle according to the claimed invention.

U.S. Pat. No. 6,199,245 B1, issued on Mar. 13, 2001 to Kenneth C. Blessing, describes a multi-component handle to obtain a handle configuration desired by a user for a particular application. The Blessing patent does not suggest an ergonomically designed tool handle according to the claimed invention. However, these modifications embody a tool with more complex construction and/or bulky or cumbersome shape and do not necessarily remedy the problem of rotational stress to the wrist, elbow and shoulder caused while gripping the tool handle with the non-lifting hand.

There is a need in the art for improvements in ergonomic tool handles that are not cumbersome and are acceptable to a user. Specifically, the prior art is deficient in an ergonomic tool handle having a single shaft and handle design that provides a curved gripping end that reduces stress on the wrist, elbow and shoulder during use. The present invention fulfills this long-standing need and desire in the art.

### SUMMARY OF THE INVENTION

The present invention is directed to a tool handle for a tool head. The tool handle comprises an elongate shaft having a work end adaptable to be secured to a tool head and a downwardly curved gripping end. The present invention is directed to a related tool handle that further comprises a cushioning material, a material effective to improve a grip or a combination thereof. These materials may be disposed on the exterior surface of the work end, of the gripping end or on a combination thereof.

The present invention also is directed to a tool handle for a tool head comprising separate work and gripping components. The work component has a work end adapted to be secured to a tool head and a first elongate end and a gripping component having a downwardly curved gripping end and a second elongate end. The first and second elongate ends are individually threaded and adapted to be joined by the threaded ends. The tool handle further may comprise a cushioning material and/or a material effective to improve a grip as described supra.

The present invention is directed further to another tool handle comprising separate work and gripping components. The work component has a work end adapted to be secured to a tool head and a first elongate end having a plurality of longitudinally spaced holes. The gripping component has a downwardly curved gripping end and a second elongate end including a button with a bias means exteriorally fastened to protract outwardly from the second elongate end. The first elongate end is adapted to slidably receive the second elongate end and to engage the biased button upon its alignment with one of the holes. The tool handle further may comprise a cushioning material and/or a material effective to improve a grip as described supra.

The present invention is directed further still to any of the tool handles described supra in combination with a tool head.

Other and further aspects, features, and advantages of the present invention will be apparent from the following description of the presently preferred embodiments of the invention. These embodiments are given for the purpose of disclosure.

### BRIEF DESCRIPTIONS OF THE DRAWINGS

So that the matter in which the above-recited features, advantages and objects of the invention, as well as others which will become clear, are attained and can be understood in detail, more particular descriptions of the invention briefly summarized above may be had by reference to certain embodiments thereof which are illustrated in the appended drawings. These drawings form a part of the specification. It is to be noted, however, that the appended drawings illustrate preferred embodiments of the invention and therefore are not to be considered limiting in their scope.

FIG. 1 is a side view of the tool handle with a spade tool head attached.

FIGS. 2A-2C are fragmentary views of the attachable components of the tool handle depicting how the gripping component and the work component are secured together.

### DETAILED DESCRIPTION OF THE INVENTION

In one embodiment of the present invention there is provided a tool handle for a tool head, comprising an elongate shaft having a work end adaptable to be secured to a tool head and a downwardly curved gripping end. Further to this embodiment the tool handle may comprise a cushioning material, a material effective to improve a grip or a combination thereof disposed on the exterior surface of the work end, of the gripping end or on a combination thereof.

In aspects of these embodiments, the elongate shaft comprises a separate work component including the work end and a first elongate end and a separate gripping component including the downwardly curved gripping end and a second elongate end, where the first and second elongate ends are adapted to be joined together. In all aspects of these embodiments the downwardly curved gripping end forms an obtuse included angle with a centerline through the elongate shaft. Representative obtuse angles may be about 117 degrees to about 157 degrees.

In one particular aspect, the first and second elongate ends individually are threaded on the exterior surfaces thereof, where the tool handle further comprises a joining sleeve interiorally threaded and adapted to threadably receive therein the first and the second elongate threaded ends. In another particular aspect the first elongate end is threaded on an interior surface and the second elongate end is threaded on an exterior surface. In yet another particular aspect the first elongate end comprises a plurality of longitudinally spaced holes and the second elongate end comprises a button with a bias means exteriorally fastened to protract outwardly therefrom, where the first elongate end is adapted to slidably receive the second elongate end and to engage the biased button upon its alignment with one of the holes.

In another embodiment of this invention there is provided a tool handle for a tool head, comprising a work component having a work end adapted to be secured to a tool head and a first elongate end; and a gripping component having a downwardly curved gripping end and a second elongate end where the first and second elongate ends are individually threaded and adapted to be joined thereby. Further to this embodiment the tool handle may comprise a cushioning material and/or an improved grip material as described supra.

In one aspect of these embodiments the first and second elongate ends are threaded on the exterior surfaces thereof, where the tool handle further comprises a joining sleeve interiorally threaded and adapted to threadably received therein the first and the second elongate threaded ends. In another aspect the first elongate end is threaded on an interior surface and the second elongate end is threaded on an exterior surface. In all aspects of these embodiments the obtuse angle is as described supra.

In yet another embodiment of the present invention there is provided a tool handle for a tool head, comprising a work component having a work end adapted to be secured to a tool head and a first elongate end having a plurality of longitudinally spaced holes; and a gripping component having a downwardly curved gripping end and a second elongate end having a button with a bias means exteriorally fastened to protract outwardly therefrom, where the first elongate end is adapted to slidably receive the second elongate end and to engage the biased button upon its alignment with one of the holes.

Further to this embodiment the tool handle may comprise a cushioning material and/or an improved grip material as described supra. In all aspects of these embodiments the obtuse angle is as described supra.

In still another embodiment of the present invention there is provided a tool handle as described supra in combination with a tool head. Examples of a tool head are a shovel blade, a spade blade or a scraper blade.

As used herein, the term, “a” or “an” may mean one or more. As used herein in the claim(s), when used in conjunction with the word “comprising”, the words “a” or “an” may mean one or more than one. As used herein “another” or “other” may mean at least a second or more.

As used herein, the terms “downwardly” and “outwardly” refer to directions from a centerline extending through the elongate portion of the tool handle shaft whether of single or component construction.

Provided herein is an ergonomically designed tool handle for a tool head, such as, but not limited to, shovel, spade, scraper, hoe, rake or broom heads. Generally, the tool handle is an elongate shaft with a work portion adapted to receive and to secure or attach the tool head at the work end of the shaft and a downwardly curved portion at the gripping end of the shaft. The curved gripping end provides for a more normal or neutral orientation of the wrist, elbow and shoulder in relation to the torso during use. When holding the curved end of the handle described herein, the elbow is positioned closer to the body reducing rotational stress on the wrist and/or the shoulder as occurs with inline grips or D-handles from the more extreme pronation or supination required of the wrist when gripping. The tool handle is durable, reliable in use, easily constructed and manufactured from standard materials and easily secured to a tool head.

The tool handle may be a single piece solid construction of known materials such as wood, fiberglass, plastic or a tubular material, e.g., steel or aluminum tubing, traditionally used in the manufacture of handles for garden and lawn tools or construction tools. The work end of the elongate shaft may be fixedly connected to the tool head by known and standard means, for example, but not limited to, screws, bolts, rivets, or spot welding. Suitable attachment means are dependent upon the material used for the elongate shaft and the type of tool head attached thereto and easily are recognized by one of skill in the art.

Alternatively, the tool handle may be constructed such that the elongate shaft comprises a work component having the work end of the shaft and an elongate attaching end and a separate gripping component having the gripping end of the shaft and an elongate attaching end. The gripping component itself has an elongate end of sufficient length and diameter to engage with the work component to form the tool handle with a curved gripping end. For example, the exterior surfaces of the elongate attaching ends of the work component and of the gripping component may be threaded such that the components can be aligned to form the tool handle by threading each end into a threaded opening of a joining sleeve of suitable geometry. Prior to threading, the threaded elongate ends and the interior surface of the joining sleeve may be coated with a suitable adhesive or glue as is known in the art for added structural stability.

Also, alternatively, the elongate ends or the entirety of the work and gripping components of the elongate shaft may be hollow. In addition, the elongate end of the gripping component may be an exteriorly threaded end to engage the interiorly threaded elongate end of the work component to form the tool handle. The gripping component may have an elongate end of varying lengths to accommodate individuals of different heights. For example, gripping components may have elongate ends of about 6 in to about 12 inches so that, when threaded within the elongate end of the work component, the length of the shaft to the curved gripping end of the gripping component is extended by that length. Thus, gripping components of various lengths are interchangeable so that the tool handle is easily adjusted for length. Providing a plurality of interchangeable gripping components for the work components, including a tool head, is of benefit when the tool is used by multiple persons, for example, by landscaping or groundskeeping crews.

Length of the tool handle also may be adjusted by providing a gripping component of the elongate shaft that has an elongate end sized for positioning within the elongate end of the work component. The elongate end of the work component comprises a plurality of longitudinally spaced holes at evenly spaced intervals along the shaft of the work component. The elongate end of the gripping component has a button with a bias means, e.g., a spring, as are known and standard in the art, mounted within the elongate end of the gripping component. The bias means keeps the button retracted when the elongate end of the gripping component is positioned within the elongate end of the work component until the button engages one of the longitudinally spaced holes. Protraction of the button through the hole secures the gripping component within the work component at the desired length. The gripping component is released or readjusted by pushing or retracting the button and sliding the gripping component.

The elongate shaft of the tool handle may have or be adjustable to a length of about 43 inches to about 57 inches excluding the length of the curved portion of the gripping end. The curved gripping portion of the gripping end of the elongate shaft may be about 4 inches to about 7 inches to accommodate differing hand sizes including gloved hands, such as hands encased in work gloves. A cross-sectional diameter of the elongate shaft may be about 1 inch to about 2 inch. For a tool handle comprising component parts, the cross-sectional diameter of the gripping component may be less than that of the work component to allow the gripping component to thread into or insert into an end of the work component. The curved gripping portion extends downwardly from a centerline through the elongate shaft at an included obtuse angle. For example, the included angle may be about 117 degrees to about 157 degrees.

The gripping portion of the gripping end of the elongate shaft may be covered with a cushioning material and/or a material to improve a user's grip to cushion a user's hand or to ensure a sturdy stable grip when gripping the curved gripping portion. A portion of the work end of the elongate shaft extending toward the gripping end also may be covered with such materials. For example, about a 12 inch length of the work portion of the elongate shaft may be covered with a suitable material disposed around the exterior surface of the elongate shaft. Such length accommodates various hand positions of different users in gripping along the work end of the elongate shaft together with gripping the curved gripping end to effectively work the tool head. As known in the art, such materials may be, but are not limited to, foam, rubber, or vinyl or a combination thereof.

In use, the curved gripping end of either the single elongate shaft or of the gripping component thereof provides the advantages of an ergonomic grip allowing the wrist, elbow and shoulder to maintain a more neutral position than possible with an inline grip or D-handle grip. In gripping the curved gripping end, a user has more control over the tool head during digging, lifting, scraping, sweeping or other motions necessary to properly use the tool. For example, the hand gripping the curved gripping portion is less likely to slip down the elongate shaft during digging as would occur with an inline grip and requires significantly less supination of the wrist and rotation of the shoulder than with a D-handle. Also, control is provided against torsional force that causes a tool head, e.g., a shovel, to rotate or roll about the handle when lifting a load, particularly an unevenly distributed load, thereby spilling.

The adjustable length of the tool handle ensures that a user may select a length suitable for him or her. Adjusting the length of the gripping component so that the curved gripping end is gripped at a height equivalent to about the center of gravity of the user, a greater degree of control over the tool head is maintained during use. The curved gripping portion also provides a greater degree of control over guiding a tool head suitable for shoveling or scraping along a surface.

Embodiments of the present invention are better illustrated with reference to the Figures, however, such reference is not meant to limit the present invention in any fashion. The embodiments and variations described in detail herein are to be interpreted by the appended claims and equivalents thereof.

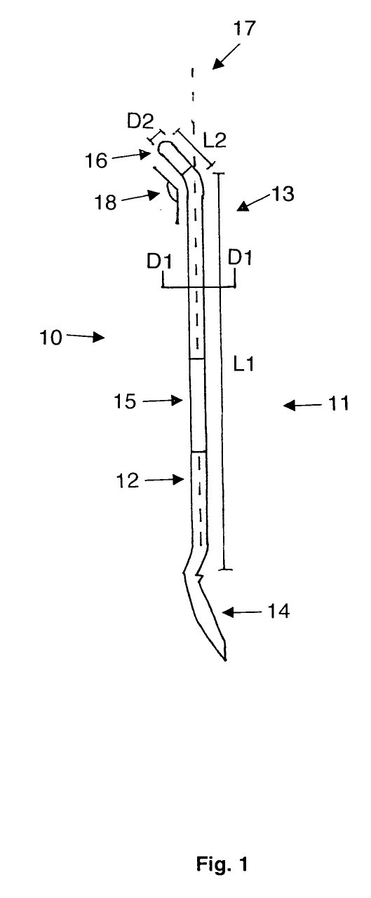

FIG. 1 depicts the tool handle with a tool head attached. A single piece tool handle 10 comprises an elongate shaft 11 having a work end 12 and a curved gripping end 13. The work end 12 is secured to a tool head 14, e.g., a shovel blade or a spade blade. The work end 12 may comprise a sleeve 15 of cushioned material or material effective to improve grip or a combination disposed around the elongate shaft 11 of the work end 12. The curved gripping end 13 also may comprise a cushioned material 16 attached thereon.

As exemplified in FIG. 1, the elongate shaft has a length L1 of 43 inches and a diameter D1 of about 1.25 inches. The curved gripping end has a length L2 of 5 inches and a diameter D2 of 1.25 inches. The curved gripping end 13 curves downwardly from a centerline 17 through the elongate shaft 11 to form an included angle 18 of 135 degrees.

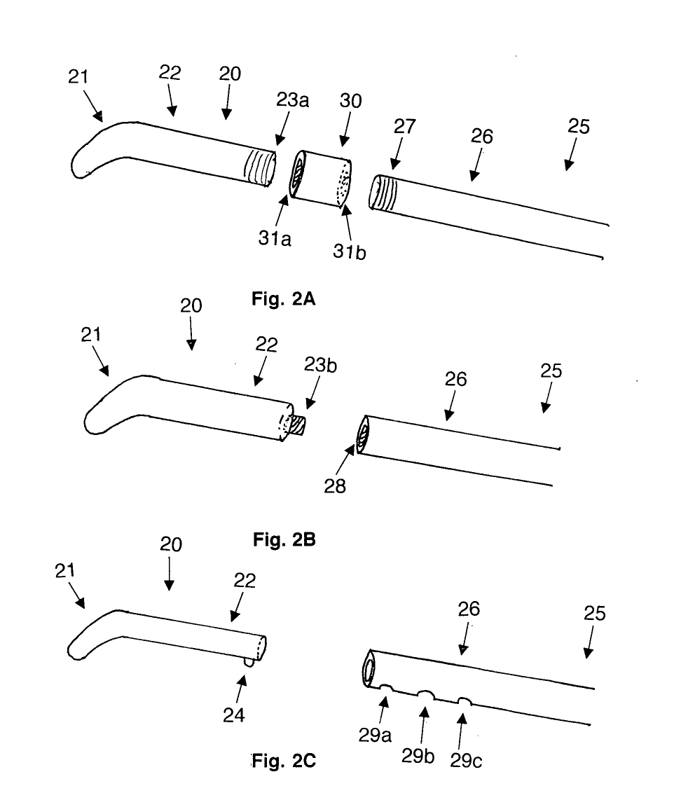

FIGS. 2A-2C are fragmentary views of the attachable and/or adjustable components of the tool handle. FIG. 2A depicts an attachable gripping component 20 having a gripping end 21 and an elongate end 22 with an exteriorally threaded tip 23a. An elongate end 26 of the work component 25 also has an exteriorally threaded tip 27. Both elongate ends 22,26 are adapted to engage individually a joining sleeve 30 of suitable geometry and dimensions comprising opposite open ends 31a,b each having interior threads suitable to receive the threaded elongate tips 23a,27 therein. When both elongate tips 23a,27 are threadingly engaged with the sleeve 30, the tool handle 10 is formed as shown in FIG. 1.

In FIG. 2B, the attachable gripping component 20 has the gripping end 21 and an elongate end 22 with an exteriorly threaded tip 23b of lesser diameter than of exteriorly threaded tip 23a. The elongate end 26 of the work component 25 is hollow and has interior threads 28 and is adapted to receive the exteriorally threaded elongate tip 23b of the gripping component 20. As with FIG. 2A, the tool handle 10 is formed when the gripping elongate tip 23b is threadingly engaged within the interiorally threaded work elongate end 28.

In FIG. 2C, the attachable gripping component 20 has the gripping end 21 and an elongate end 22 with a button 24 comprising a bias means disposed thereon at the tip. The elongate end 26 of the work component is hollow and comprises longitudinally and evenly spaced holes 29a,b,c therethrough. The elongate end 22 of the gripping component 20 has a diameter less than that of the elongate work end 26 and is adapted to slidably engage the elongate work end 26 along its length until the biased button 24, which is retracted inside the elongate work end 26 when slidably engaged, aligns with one of the spaced holes 29a,b.c and protracts therethrough. As with FIGS. 2A-2B, the tool handle 10 is formed thereby.

Any patents or publications mentioned in this specification are indicative of the levels of those skilled in the art to which the invention pertains. Further, these patents and publications are incorporated by reference herein to the same extent as if each individual publication was specifically and individually incorporated by reference.

One skilled in the art will appreciate readily that the present invention is well adapted to carry out the objects and obtain the ends and advantages mentioned, as well as those objects, ends and advantages inherent herein. Changes therein and other uses which are encompassed within the spirit of the invention as defined by the scope of the claims will occur to those skilled in the art.

What is claimed is:

1. A tool handle for a tool head, comprising:
an elongate shaft having a work end adaptable to be secured to a tool head and a downwardly curved gripping end.

2. The tool handle of claim 1, further comprising a cushioning material, a material effective to improve a grip or a combination thereof disposed on the exterior surface of said work end, of said gripping end or on a combination thereof.

3. The tool handle of claim 1, wherein said elongate shaft comprises a separate work component including the work end and a first elongate end and a separate gripping component including the downwardly curved gripping end and a second elongate end, said first and second elongate ends adapted to be joined together.

4. The tool handle of claim 3, wherein said first and second elongate ends individually are threaded on the exterior surfaces thereof, said tool handle further comprising:
a joining sleeve interiorally threaded and adapted to threadably receive therein said first and said second elongate threaded ends.

5. The tool handle of claim 3, wherein said first elongate end is threaded on an interior surface and said second elongate end is threaded on an exterior surface.

6. The tool handle of claim 3, wherein said first elongate end comprises a plurality of longitudinally spaced holes and said second elongate end comprises a button with a bias means exteriorally fastened to protract outwardly therefrom, said first elongate end adapted to slidably receive the second elongate end and to engage said biased button upon its alignment with one of the holes.

7. The tool handle of claim 1, wherein said downwardly curved gripping end forms an obtuse included angle with a centerline through said elongate shaft.

8. The tool handle of claim 1, wherein said included obtuse angle is about 117 degrees to about 157 degrees.

9. The tool handle of claim 1 in combination with a tool head.

10. The tool handle of claim 9, wherein said tool head comprises a shovel blade, a spade blade, or a scraper blade.

11. A tool handle for a tool head, comprising:
a work component having a work end adapted to be secured to a tool head and a first elongate end; and
a gripping component having a downwardly curved gripping end and a second elongate end, said first and second elongate ends individually threaded and adapted to be joined thereby.

12. The tool handle of claim 11, further comprising a cushioning material, a material effective to improve a grip or a combination thereof disposed on the exterior surface of said work end, of said gripping end or a combination thereof.

13. The tool handle of claim 11, wherein said first and second elongate ends are threaded on the exterior surfaces thereof, said tool handle further comprising:
a joining sleeve interiorally threaded and adapted to threadably received therein said first and said second elongate threaded ends.

14. The tool handle of claim 11, wherein said first elongate end is threaded on an interior surface and said second elongate end is threaded on an exterior surface.

15. The tool handle of claim 11, wherein said downwardly curved gripping end forms an obtuse included angle with a centerline through said elongate shaft.

16. The tool handle of claim 15, wherein said included obtuse angle is about 117 degrees to about 157 degrees.

17. The tool handle of claim 11 in combination with a tool head.

18. The tool handle of claim 17, wherein said tool head comprises a shovel blade, a spade blade, or a scraper blade.

19. A tool handle for a tool head, comprising:
a work component having a work end adapted to be secured to a tool head and a first elongate end having a plurality of longitudinally spaced holes; and
a gripping component having a downwardly curved gripping end and a second elongate end having a button with a bias means exteriorally fastened to protract outwardly therefrom, said first elongate end adapted to slidably receive the second elongate end and to engage said biased button upon its alignment with one of the holes.

20. The tool handle of claim 19, further comprising a cushioning material, a material effective to improve a grip or a combination thereof disposed on the exterior surface of said work end, of said gripping end or a combination thereof.

21. The tool handle of claim 19, wherein said downwardly curved gripping end forms an obtuse included angle with a centerline through said elongate shaft.

22. The tool handle of claim 19, wherein said included obtuse angle is about 117 degrees to about 157 degrees.

23. The tool handle of claim 22 in combination with a tool head.

24. The tool handle of claim 23, wherein said tool head comprises a shovel blade, a spade blade, or a scraper blade.
